(19) United States
(12) Patent Application Publication
(10) Pub. No.: US 2026/0057188 A1
(43) Pub. Date: Feb. 26, 2026

(54) INFORMATION PROCESSING DEVICE, INFORMATION PROCESSING METHOD, AND INFORMATION PROCESSING SYSTEM

(71) Applicant: Toshiba Tec Kabushiki Kaisha, Tokyo (JP)

(72) Inventor: Hiroshi IWASAKI, Susono Shizuoka (JP)

(21) Appl. No.: 19/246,157

(22) Filed: Jun. 23, 2025

(30) Foreign Application Priority Data
Aug. 20, 2024 (JP) 2024-138477

(51) Int. Cl. G06F 40/40; G06F 40/289

(52) U.S. Cl. CPC G06F 40/40; G06F 40/289

(57) ABSTRACT

According to one embodiment, an information processing device includes a communication interface and a control unit that receives an inquiry sentence from a user, classifies the inquiry sentence by submitting the inquiry sentence to a classification model, generates a prompt from the inquiry sentence, then inputs the prompt to a generative AI to receive a response sentence. The control unit then classifies the response sentence by submitting the response sentence to the classification model, then determines whether the inquiry sentence classification matches the response sentence classification. The control unit outputs the response sentence to the user via the communication interface when the classifications are determined to be similar, but generates another prompt from the inquiry sentence to be input to the generative AI when the classifications are dissimilar.

### CROSS-REFERENCE TO RELATED APPLICATION

This application is based upon and claims the benefit of priority from Japanese Patent Application No. 2024-138477, filed Aug. 20, 2024, the entire contents of which are incorporated herein by reference.

### FIELD

Embodiments described herein generally relate to an information processing device, an information processing method, and an information processing system.

### BACKGROUND

In recent years, a natural language processing system incorporating generative artificial intelligence (AI), such as a large language model (LLM), that can generate a natural response sentence upon input of a prompt or query has been developed.

Such a large language model can generate and output an answer sentence for an inquiry from a user in a particular format. However, in many cases, an answer irrelevant to the user inquiry may be generated. In some models that quantize data for reducing the bit width of the data to be handled, high-speed text generation can be implemented, but the inference accuracy is often inferior to that of other type models, meaning an irrelevant answer may be generated more often.

### BRIEF DESCRIPTION OF THE DRAWINGS

FIG. 1 is a schematic diagram of an information processing system according to a first embodiment.

FIG. 2 is a block diagram of an interface device according to a first embodiment.

FIG. 3 is a block diagram of a text generation device.

FIG. 4 is a functional block diagram of an interface device.

FIG. 5 is a functional block diagram of a text generation device.

FIG. 6 is a sequence diagram illustrating an example of control processing performed by an interface device and a text generation device.

FIG. 7 is a block diagram of an interface device according to a second embodiment.

FIG. 8 is a functional block diagram of an interface device according to a second embodiment.

FIG. 9 is a functional block diagram of a functional configuration of a text generation device according to a second embodiment.

### DETAILED DESCRIPTION

Embodiments provide an information processing device, an information processing method, and an information processing system providing a technological solution to existing problems in the related art related to the accuracy of AI-generated answers to user inquiries. As such, embodiments represent a technological improvement to existing related art systems.

In general, according to one embodiment, an information processing device includes a communication interface and a control unit. The control unit is configured to: receive an inquiry sentence from a user via the communication interface; classify the inquiry sentence by submitting the inquiry sentence to a classification model; generate a prompt from the inquiry sentence; input the prompt to a generative AI to receive a response sentence from the generative AI; classify the response sentence by submitting the response sentence to the classification model; determine whether the classification of the inquiry sentence is similar to the classification of the response sentence; output the response sentence to the user via the communication interface when the classification of the inquiry sentence and the response sentence are determined to be similar; generate another prompt from the inquiry sentence and submit the other prompt to the generative AI to receive a second response sentence from the generative AI when the classification of the inquiry sentence and the response sentence are determined to be dissimilar; classify the second response sentence by submitting the second response sentence to the classification model; and output the second response sentence to the user via the communication interface when the classification of the inquiry sentence and the second response sentence are determined to be similar.

Hereinafter, an information processing device, an information processing method, and an information processing system according to certain example embodiments will be described with reference to the drawings. The present disclosure is not limited to the specific example embodiments.

### First Embodiment

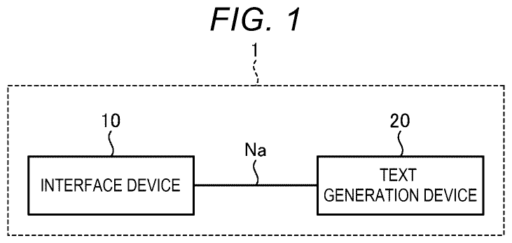

FIG. 1 is a schematic diagram illustrating an example of a schematic configuration of an information processing system 1 according to a first embodiment. As illustrated in FIG. 1, the information processing system 1 includes an interface device 10 and a text generation device 20. In the present example, information processing system 1 can be used by a store, such as a retail store, that provides a service on the Web for answering various inquiries from a customer (also referred to as a user) who accesses the information processing system 1. The interface device 10 and the text generation device 20 are communicably connected by wire or wirelessly by network Na.

The interface device 10 is, for example, a terminal device such as a personal computer (PC). The interface device 10 exchanges various types of information with the text generation device 20. In some examples, interface device 10 may be a mobile terminal such as a smartphone or a tablet terminal.

In use, the interface device 10 acquires an inquiry sentence (inquiry) from the user. The interface device 10 transmits the acquired inquiry sentence to the text generation device 20. Upon receiving an answer sentence (a response to the inquiry) from the text generation device 20, the interface device 10 outputs (e.g., displays) the received answer sentence to the user. Here, the answer sentence is text providing an answer or response content to the inquiry sentence or content included therein.

The text generation device 20 is an example of an information processing device. The text generation device 20 generates the answer sentence based on the inquiry sentence from the interface device 10. The text generation device 20 also acquires a classification result by classifying the inquiry sentence and the answer sentence based on a predetermined (preset) classification index. The text generation device 20 outputs the answer sentence to the interface device 10 based on the classification result.

In the present embodiment, the text generation device 20 is described as being implemented by a single device, but may be implemented by a plurality of devices. In other examples, interface device 10 and the text generation device 20 may be combined as an integrated (single) device.

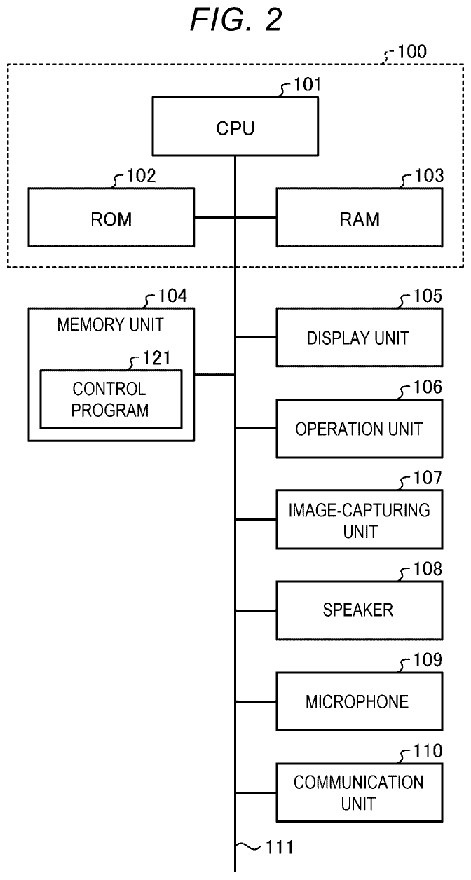

Next, a hardware configuration of the interface device 10 will be described. FIG. 2 is a block diagram illustrating an example of a hardware configuration of the interface device 10 according to the first embodiment.

As illustrated in FIG. 2, the interface device 10 includes a central processing unit (CPU) 101 that is an example of a processor, a read only memory (ROM) 102, a random access memory (RAM) 103, a memory unit 104, a display unit 105, an operation unit 106, an image-capturing unit 107, a speaker 108, a microphone 109, and a communication unit 110.

The CPU 101 is one example of a processor. CPU 101 centrally controls units of the interface device 10. The ROM 102 stores various programs. The RAM 103 is a workspace for programs and various types of data.

As a processor of a control unit 100, another processor type may be provided instead of the CPU 101 or in addition to the CPU 101. As other processors, various processors such as a graphics processing unit (GPU), a neural network processing unit (NPU), and a digital signal processor (DSP), or a dedicated arithmetic circuit implemented by an application specific integrated circuit (ASIC) or a field programmable gate array (FPGA) can be appropriately used.

The memory unit 104 is a nonvolatile memory such as a hard disc drive (HDD) or a flash memory in which stored information is held even when a power supply is cut off. The memory unit 104 includes a control program 121.

The control program 121 stores a control program for controlling the interface device 10. The CPU 101, the ROM 102, the RAM 103, and the memory unit 104 are connected via a bus 111. The CPU 101, the ROM 102, and the RAM 103 constitute the control unit 100. That is, the control unit 100 executes control processing of the interface device 10 by the CPU 101 operating according to the instructions of the control program 121 stored in the ROM 102 or the memory unit 104 and loaded onto the RAM 103.

The control unit 100 is connected to the display unit 105, the operation unit 106, the image-capturing unit 107, the speaker 108, the microphone 109, and the communication unit 110 via the bus 111.

The display unit 105 is a display device such as a liquid crystal display (LCD). The display unit 105 displays various types of information under the control of the CPU 101.

The operation unit 106 receives various inputs from the user. The operation unit 106 is, for example, a touch panel on a display surface of the display unit 105. The operation unit 106 may be or incorporate an input device such as a keyboard or a pointing device.

The image-capturing unit 107 is an image-capturing device (e.g., a camera) including an imaging sensor such as a charge coupled device (CCD) or a complementary metal oxide semiconductor (CMOS). For example, the image-capturing unit 107 captures an image according to an instruction from the user who operates the interface device 10.

The speaker 108 is an example of an audio output device. The speaker 108 outputs audio data sent from the CPU 101 as audio.

The microphone 109 is an example of an audio input device. The microphone 109 acquires audio, such as speech, from the user as audio data and outputs the acquired audio data to the CPU 101.

The communication unit 110 is a communication interface such as a LAN interface (I/F). The communication unit 110 is connected to a network Na. The communication unit 110 transmits and receives various types of information to and from the text generation device 20 via the network Na. The communication unit 110 can be connected to a network such as the Internet or another information processing device under the control of the control unit 100 or otherwise.

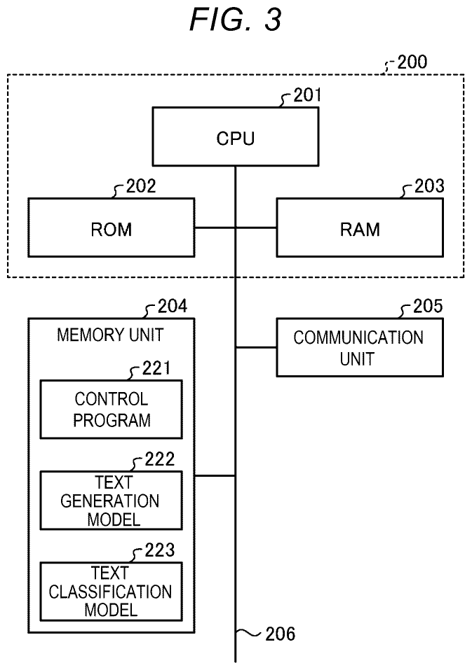

Next, a hardware configuration of the text generation device 20 will be described. FIG. 3 is a block diagram illustrating an example of the hardware configuration of the text generation device 20 according to the first embodiment.

As illustrated in FIG. 3, the text generation device 20 includes a CPU 201 that is an example of a processor, a ROM 202, a RAM 203, a memory unit 204, and a communication unit 205.

The CPU 201 controls the units of the text generation device 20. The ROM 202 stores various programs. The RAM 203 is a workspace for programs and various types of data.

The memory unit 204 is a nonvolatile memory such as a HDD or a flash memory in which stored information is held even when a power supply is cut off. The memory unit 204 includes a control program 221, a text generation model 222, and a text classification model 223.

The control program 221 stores a control program for controlling the text generation device 20. The CPU 201, the ROM 202, the RAM 203, and the memory unit 204 are connected to one another via a bus 206. The CPU 201, the ROM 202, and the RAM 203 constitute a control unit 200. The control unit 200 executes control processing of the text generation device 20 by the CPU 201 operating according to the instructions of control program 221 stored in the ROM 202 or the memory unit 204 and loaded onto the RAM 203.

The text generation model 222 is a learning model (AI learning model) for generating text. The text generation model 222 can be implemented using, for example, a decoder model among transformer models. The text generation model 222 is an example of a generative AI that generates text. The text generation model 222 receives an input of text (also referred to as a prompt) that is generated from or based on the inquiry sentence from the user, then generates the answer sentence corresponding to the inquiry sentence. The text generation model 222 may incorporate a known-type of machine learning model or deep learning model such as a generative pre-trained transformer (GPT) or Large Language Model Meta AI (Llama).

The text generation model 222 has a function of generating and then outputting an answer sentence based on a condition such as the inquiry content of a prompt in which the condition is described.

The text generation model 222 may be fine-tuned or specifically trained to suit an intended end use of the information processing system 1. The fine-tuning may involve changing the content of an answer to the input prompts or may involve changing expressions in output sentences. For example, the text generation model 222 used in the present embodiment may have completed learning of specific expressions set in view of such considerations as the store-specific intended tone of response speech and the vocabulary appropriate to the end user store in which the information processing system 1 is to be used.

The text generation model 222 may receive an input of a prompt secondarily generated based on an inquiry sentence from the user and certain supplementary information acquired from an external storage device to generate an answer sentence in response to the inquiry sentence. The prompt may be generated in view of the supplementary information by using a known natural language processing technique such as retrieval-augmented generation (RAG).

The text classification model 223 is a learning model for classifying texts. The text classification model 223 can be implemented using, for example, an encoder model among transformer models. The text classification model 223 may use a known-type of machine learning model or deep learning model such as bidirectional encoder representations from transformers (BERT).

When receiving text such as the inquiry sentence or the answer sentence, the text classification model 223 in the present embodiment classifies the received text based on content thereof. The classification method and the number of possible classifications are not particularly limited. The text classification model 223 in this example classifies the received text based on a predetermined classification index. For example, when receiving the inquiry sentence or the answer sentence, the text classification model 223 outputs a classification result expressed in a vector format calculated by a known-type natural language processing technique.

The classification method of the text classification model 223 may be fine-tuned or specifically trained according to the end use of the information processing system 1. For example, the text classification model 223 may be fine-tuned to classify the genre (e.g. a general type) of the text in the inquiry sentence or the answer sentence. The text classification model 223 may be fine-tuned to classify by an emotion (user emotion) considered to be represented by the text in the inquiry sentence or the answer sentence.

The control unit 200 is connected to the communication unit 205 via the bus 206. The communication unit 205 is a communication interface such as a LAN I/F. The communication unit 205 is connected to the network Na. The communication unit 205 transmits and receives various types of information to and from, for example, the interface device 10 via the network Na. The communication unit 205 can be connected to a network such as the Internet or another information processing device under the control of the control unit 200.

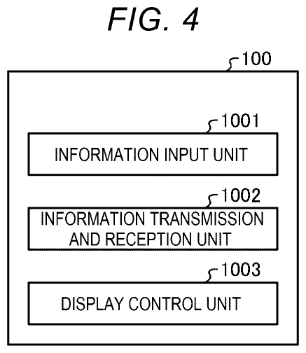

Next, a functional configuration of the interface device 10 will be described. FIG. 4 is a block diagram illustrating an example of the functional configuration of the interface device 10 according to the first embodiment.

As illustrated in FIG. 4, the control unit 100 of the interface device 10 provides the functions of an information input unit 1001, an information transmission and reception unit 1002, and a display control unit 1003.

Specifically, the control unit 100 (CPU 101) executes the control program 121 stored in the memory unit 104 to implement the functional configuration described above. In the present embodiment, the functional configuration described above is a software configuration implemented by cooperation between a processor (e.g., CPU 101) in the interface device 10 and the program. However, the functional configuration is not limited thereto and may be a hardware configuration in which a part of or the whole of the described functions may be implemented using a dedicated circuit or the like. The functional configuration of the interface device 10 is not limited to that depicted in FIG. 4.

The information input unit 1001 acquires the information input to the interface device 10 from the user. That is, the information input unit 1001 receives the information input by the user. For example, the information input unit 1001 acquires the inquiry sentence input by a user operation of the operation unit 106.

The information transmission and reception unit 1002 is an example of a transmission unit. The information transmission and reception unit 1002 transmits and receives various types of information to and from the text generation device 20 via the communication unit 110. For example, the information transmission and reception unit 1002 transmits the inquiry sentence acquired by the information input unit 1001 to the text generation device 20. The information transmission and reception unit 1002 then receives the answer sentence (text) from the text generation device 20.

The display control unit 1003 displays various types of information on the display unit 105. For example, the display control unit 1003 displays a screen on the display unit 105 for supporting the input of the inquiry sentence by the user. The display control unit 1003 displays the answer sentence on the display unit 105 when acquired by the information transmission and reception unit 1002.

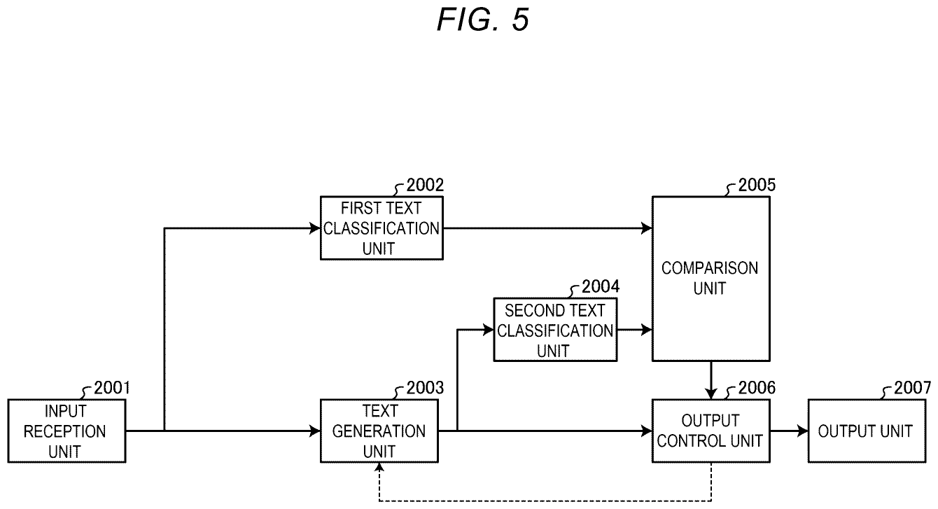

Next, a functional configuration of the text generation device 20 will be described. FIG. 5 is a block diagram illustrating an example of the functional configuration of the text generation device 20 according to the first embodiment.

As illustrated in FIG. 5, the control unit 200 of the text generation device 20 provides the functions of an input reception unit 2001, a first text classification unit 2002, a text generation unit 2003, a second text classification unit 2004, a comparison unit 2005, an output control unit 2006, and an output unit 2007.

Specifically, the control unit 200 (CPU 201) executes the control program 221 stored in the memory unit 204 to implement the functional configuration described above. In the present embodiment, the functional configuration described above is a software configuration implemented by cooperation between the processor of the text generation device 20 and the program. However, the functional configuration is not limited thereto and described functions may be implemented in whole or in part using a dedicated circuit or the like. The functional configuration of the text generation device 20 is not limited to that depicted.

The input reception unit 2001 is an example of an acquisition unit. The input reception unit 2001 acquires the inquiry sentence including the inquiry content as input by the user. Specifically, the input reception unit 2001 acquires an inquiry sentence transmitted from the interface device 10 via the communication unit 205. The input reception unit 2001 temporarily stores (holds) the acquired inquiry sentence in the RAM 203.

The first text classification unit 2002 is one example of a classification unit. The first text classification unit 2002 sends the inquiry sentence to the text classification model 223 and acquires a classification result from the text classification model 223.

Specifically, the first text classification unit 2002 inputs the inquiry sentence (acquired by the input reception unit 2001) to the text classification model 223. The first text classification unit 2002 thus acquires a first classification result from the text classification model 223. The first classification result is one example of a classification result. The first text classification unit 2002 temporarily stores (holds) the first classification result in the RAM 203.

The text generation unit 2003 is one example of a generation unit. The text generation unit 2003 generates a prompt from the inquiry sentence and then inputs the prompt to the text generation model 222 which generates an answer sentence in view of the inquiry content.

Specifically, the text generation unit 2003 generates a prompt reflecting the inquiry sentence acquired by the input reception unit 2001. The text generation unit 2003 then inputs the generated prompt to the text generation model 222. The text generation unit 2003 acquires an answer sentence from the text generation model 222. The text generation unit 2003 temporarily stores (holds) the acquired answer sentence in the RAM 203.

In this context, the generated prompt incorporates an instruction sentence that provides instructions related to the format and incorporated details for the answer sentence to be generated. For example, the prompt includes specific instruction content such as “output an answer according to the gist of the inquiry content”. The generation of the prompt may be configured to be switched between a plurality of types of templates that may be selected depending on the specific language or content of the inquiry sentence.

The second text classification unit 2004 is one example of a classification unit. The second text classification unit 2004 sends the answer sentence to the text classification model 223 and thus acquires a classification result from the text classification model 223.

Specifically, the second text classification unit 2004 inputs an answer sentence (generated by the text generation unit 2003) to the text classification model 223. The second text classification unit 2004 acquires a second classification result from the text classification model 223. Here, the second classification result is one example of a classification result.

The comparison unit 2005 compares the first classification result (acquired from the first text classification unit 2002) to the second classification result (acquired from the second text classification unit 2004).

Specifically, the comparison unit 2005 compares the first classification result to the second classification result, and then calculates the similarity (e.g., a similarity score or similarity value) between the two classification results. Here, as a calculation method of similarity, a cosine similarity between the first classification result and the second classification result may be calculated. Then, the comparison unit 2005 outputs the acquired determination result to the output control unit 2006.

The comparison unit 2005 outputs, to the output control unit 2006, a determination or indication as to whether the classifications of the first classification result (for inquiry sentence) and the second classification result (for corresponding answer sentence) match based on the calculated similarity.

The output control unit 2006 controls the output of the answer sentence according to the comparison result acquired from the comparison unit 2005.

For example, if the determined similarity acquired from the comparison unit 2005 is at or above some predetermined threshold, the output control unit 2006 causes the output unit 2007 to output the answer sentence as generated by the text generation unit 2003.

If the similarity is less than the predetermined threshold, the output control unit 2006 discards (does not output) the answer sentence and causes the text generation unit 2003 to generate another answer sentence.

For example, the output control unit 2006 sends the inquiry sentence (that was stored in the RAM 203) to the text generation unit 2003 to regenerate an answer sentence. The output control unit 2006 may instruct the text generation unit 2003 to change or add a condition in the prompt for regenerating the answer sentence. As a condition to be included in the new prompt, the classification of the inquiry sentence may be designated.

As described above, if the first classification result (inquiry sentence) and the second classification result (answer sentence) do not match (or if the similarity value is less than the threshold), the output control unit 2006 causes the text generation unit 2003 to generate a new answer sentence. If the first classification result and the second classification result match (or if the similarity is at or above the threshold), the output control unit 2006 causes the output unit 2007 to output the already generated answer sentence. Accordingly, if an irrelevant, improper, or otherwise inappropriate, answer sentence is generated for the inquiry from the user, the poor answer sentence can be prevented from being output to the user, and thus the accuracy and appropriateness of answers can be improved.

The output unit 2007 outputs various types of information to the interface device 10. For example, when receiving an instruction to transmit the answer sentence from the output control unit 2006, the output unit 2007 transmits the answer sentence to the interface device 10 via the communication unit 205.

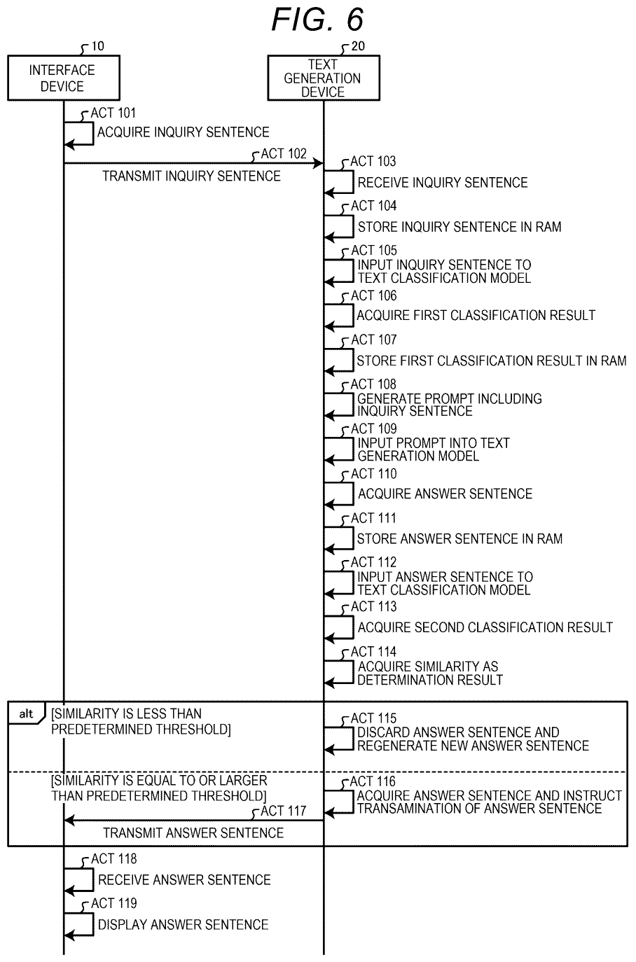

Next, the control processing of the interface device 10 and the control processing of the text generation device 20 will be described with reference to FIG. 6.

FIG. 6 is a sequence diagram illustrating an example of the control processing performed by the interface device 10 and the text generation device 20 according to the first embodiment. FIG. 6 illustrates a processing example for when an answer sentence for the inquiry sentence input via the interface device 10 is generated by the text generation device 20.

First, the information input unit 1001 of the interface device 10 acquires the inquiry sentence input by the user operation via the operation unit 106 (ACT 101). Next, the information transmission and reception unit 1002 of the interface device 10 transmits the inquiry sentence to the text generation device 20 (ACT 102).

The input reception unit 2001 of the text generation device 20 acquires the inquiry sentence transmitted from the interface device 10 (ACT 103) and stores the acquired inquiry sentence in the RAM 203 (ACT 104). Next, the first text classification unit 2002 inputs the inquiry sentence to the text classification model 223 (ACT 105) and acquires a first classification result from the text classification model 223 (ACT 106). Then, the first text classification unit 2002 stores the acquired first classification result in the RAM 203 (ACT 107).

The text generation unit 2003 generates a prompt including or otherwise reflecting the inquiry sentence (ACT 108).

Next, the text generation unit 2003 inputs the prompt to the text generation model 222 (ACT 109) to acquire the answer sentence from the text generation model 222 (ACT 110). Then, the text generation unit 2003 stores the acquired answer sentence in the RAM 203 (ACT 111).

Next, the second text classification unit 2004 inputs the answer sentence (generated by the text generation unit 2003) to the text classification model 223 (ACT 112). The second text classification unit 2004 thus acquires a second classification result from the text classification model 223 (ACT 113).

The comparison unit 2005 then compares the first classification result (acquired by the first text classification unit 2002) to the second classification result (acquired by the second text classification unit 2004), and calculates, determines, or otherwise acquires, a similarity result or the like for the classification results (ACT 114). Then, the comparison unit 2005 outputs the similarity result to the output control unit 2006.

If the similarity is less than a predetermined threshold, the output control unit 2006 discards the answer sentence and causes the text generation unit 2003 to generate a new (second) answer sentence (ACT 115).

If the similarity is at or above the predetermined threshold, the output control unit 2006 causes the output unit 2007 to output the answer sentence (ACT 116). Next, the output unit 2007 transmits the answer sentence to the interface device 10 (ACT 117).

The information transmission and reception unit 1002 of the interface device 10 receives the answer sentence from the text generation device 20 (ACT 118). Next, the display control unit 1003 displays the answer sentence on the display unit 105 (ACT 119).

As described above, the text generation device 20 according to the present embodiment includes an acquisition unit configured to acquire an inquiry sentence including an inquiry content input by a user, a generation unit configured to input a prompt (generated based on the inquiry sentence) to a generative AI and cause the generative AI to generate an answer sentence corresponding to the inquiry, a classification unit configured to classify the inquiry sentence and its answer sentence based on the content of the inquiry sentence and the answer sentence; an output unit configured to output the answer sentence, and an output control unit configured to control an output of the output unit according to the classification results of the classification unit.

Accordingly, the text generation device 20 determines whether the classification of the inquiry sentence and the classification of the answer sentence are similar and selects between regeneration of answer sentences and transmission of an answer sentence to the interface device 10 based on the determination result. That is, text generation device 20 generates a new answer sentence if there is a classification mismatch between the inquiry sentence and the answer sentence does and outputs an answer sentence only when the classifications of the inquiry sentence and the answer sentence match (or are similar enough to within a preset threshold degree). Therefore, if an irrelevant answer sentence is generated for the inquiry from the user, such an answer sentence can be prevented from being output to the user, and thus the accuracy of the answer provided to the user can be improved.

An embodiment may also be modified and implemented as appropriate by changing aspects of the configurations or the functions of each device from those described above. Hereinafter, some modifications according to an embodiment will be described as other embodiments. In the following, differences from example embodiments already described above will be mainly described, and the same reference symbols will be used for those aspects and configurations as already described. As such, detailed description of repeated or common aspects may be omitted. In addition, these described modifications may be implemented individually or in combination when appropriate.

### Second Embodiment

Next, a second embodiment will be described. In some examples, the inquiry sentence may be a short sentence. In other words, if the amount of information included in the inquiry sentence is small, the answer sentence generated by the text generation device 20 may remain similar to a previous answer sentence even when regeneration is performed due to a mismatch between inquiry classification and answer classification.

In such a case, different answer sentences may be generated by including additional information along with the inquiry sentence. For example, by adding information related to the user (hereinafter, also referred to as user-related information) in the inquiry sentence, different answer sentences can be generated, and an answer sentence more likely appropriate to the user can be generated.

Therefore, in the second embodiment, a configuration capable of generating an answer sentence based on the inquiry sentence input by the user and user-related information will be described.

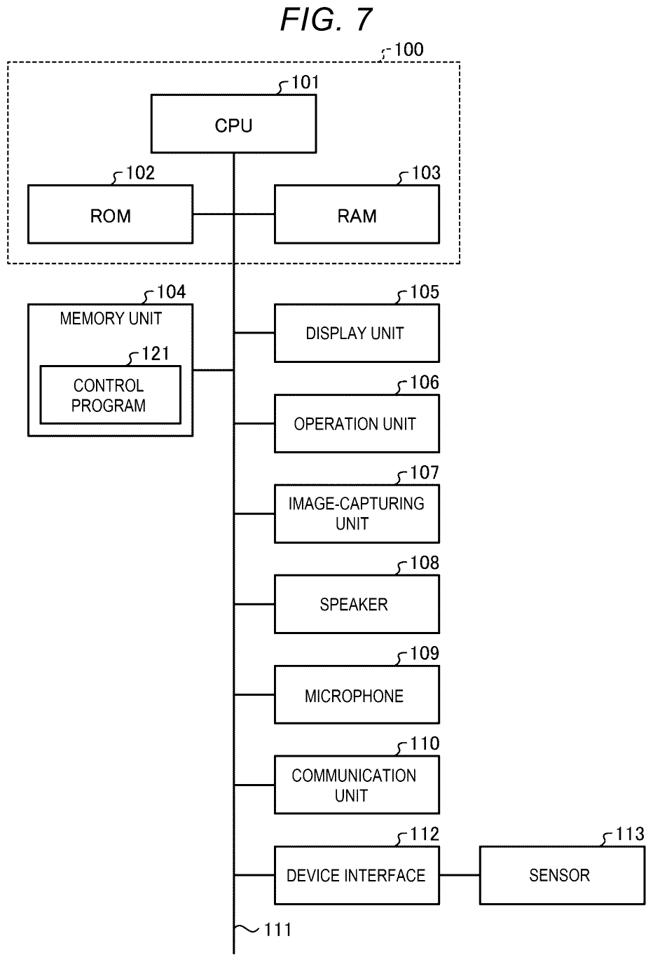

In the second embodiment, the interface device 10 acquires sensor data related to the surrounding environment of the user or the interface device 10 from various sensors 113 (see FIG. 7) and transmits the sensor data to the text generation device 20. Upon receiving the sensor data from the interface device 10, the text generation device 20 generates a prompt based on the inquiry sentence in combination with the sensor data.

First, a hardware configuration of an interface device 10 in the second embodiment will be described. FIG. 7 is a block diagram illustrating an example of a hardware configuration of the interface device 10 according to the second embodiment.

As illustrated in FIG. 7, the interface device 10 includes a device interface 112 and a sensor 113 in addition to the CPU 101, the ROM 102, the RAM 103, the memory unit 104, the display unit 105, the operation unit 106, the image-capturing unit 107, the speaker 108, the microphone 109, and the communication unit 110.

The device interface 112 acquires the sensor data from the sensor 113. The sensor data is an example of related information. If the sensor 113 outputs an analog value, the device interface 112 includes a signal processing circuit or an analog-to-digital (A/D) converter. If the sensor 113 has a communication function and transmits a measured value as digital data to the interface device 10, the device interface 112 includes a communication interface capable of communicating with the sensor 113 via wired or wireless communication. The sensor data acquired by the device interface 112 is transmitted to the control unit 100.

The sensor 113 is a sensor device that senses the surrounding environment in some manner. Here, the surrounding environment is a surrounding environment of the user and/or the interface device 10 to which an answer sentence is to be provided. The surrounding environment of the user in this context may include not only the near vicinity of the user but also general location of the user or geographic area where the user is located. For example, the information about surrounding environment may be a temperature, a humidity level, a wind speed, a current weather state, or the like for some area around the user or the interface device 10. The surrounding environment information may further include other elements or aspects.

In the second embodiment, the sensor 113 may be provided as part of the interface device 10. For example, the sensor measures data related to the surrounding environment at the position where the sensor 113 is specifically provided. Examples of the sensor 113 include a temperature sensor, a humidity sensor, an atmospheric pressure sensor, an illuminance sensor, a human presence sensor, and an ultrasonic movement sensor. Possible sensor-types for sensor 113 are not limited to those described above. Multiple sensors 113 may transmit measurement results to the device interface 112 as the sensor data. The sensor data is, for example, numerical data indicating the measurement results of the sensor 113 such as a temperature value or a humidity level. The sensor data may be analog data or digital data. The sensor data is also referred to as “environment information”.

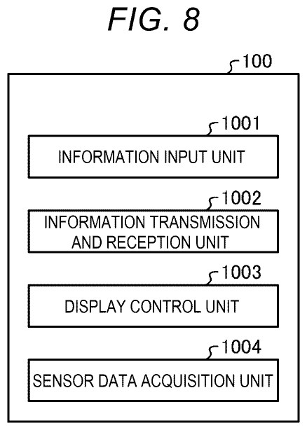

Next, a functional configuration of an interface device 10 in the second embodiment will be described. FIG. 8 is a block diagram illustrating an example of the functional configuration of the interface device 10 according to the second embodiment. The interface device 10 in the second embodiment functions as a sensor data acquisition unit 1004 in addition to the information input unit 1001, the information transmission and reception unit 1002, and the display control unit 1003. Each of the functional configurations described above may be implemented as a hardware configuration such as a dedicated circuit in the interface device 10.

The sensor data acquisition unit 1004 acquires the sensor data from one or more sensor 113. Specifically, the sensor data acquisition unit 1004 acquires the sensor data from a sensor 113 via the device interface 112. The sensor data acquisition unit 1004 may acquire the sensor data from a plurality of sensors 113.

The information transmission and reception unit 1002 of the second embodiment transmits both the inquiry sentence acquired by the information input unit 1001 and the sensor data acquired by the sensor data acquisition unit 1004 to the text generation device 20.

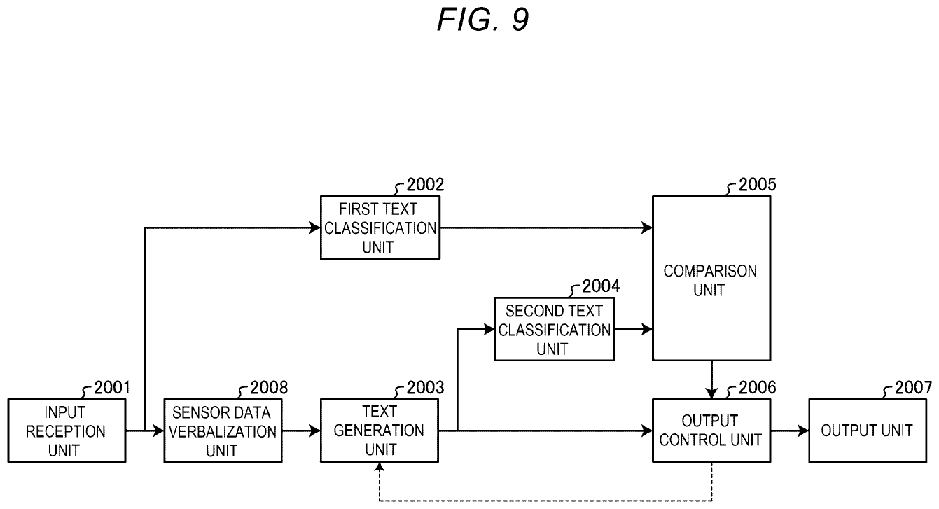

FIG. 9 is a block diagram illustrating an example of the functional configuration of the text generation device 20 according to the second embodiment. The text generation device 20 in the second embodiment functions as a sensor data verbalization unit 2008 in addition to the input reception unit 2001, the first text classification unit 2002, the text generation unit 2003, the second text classification unit 2004, the comparison unit 2005, the output control unit 2006, and the output unit 2007. Each of the functional configurations described above may be implemented as a hardware configuration such as a dedicated circuit in the text generation device 20.

The sensor data verbalization unit 2008 converts the sensor data into qualitative label text reflecting the values or information in the sensor data.

That is, upon receiving the sensor data from the interface device 10, the sensor data verbalization unit 2008 generates label text corresponding to the sensor data. In this example, the possible label texts can be set in advance for each type of sensor data expected to be supplied and the potential or expected sensor measurement values of the likes in the sensor data. For example, label of “chilly” can be set as a preset label text corresponding to a value “15°C” in the sensor data measured by a temperature sensor.

The text generation unit 2003 of the second embodiment generates a prompt based on the label text from the sensor data verbalization unit 2008 and the inquiry sentence.

Hereinafter, control processing performed by the interface device 10 and control processing performed by the text generation device 20 of the second embodiment will be described with reference to a sequence diagram of FIG. 6. Processing contents different from those of the first embodiment will be described.

First, the information transmission and reception unit 1002 transmits the inquiry sentence and the sensor data (acquired by the sensor data acquisition unit 1004) to the text generation device 20 in ACT 102.

The input reception unit 2001 of the text generation device 20 receives both the inquiry sentence and the sensor data from the interface device 10 in ACT 103. As such, the sensor data verbalization unit 2008 acquires the label text corresponding to the sensor data. Then, in ACT 108, the text generation unit 2003 generates the prompt based on the inquiry sentence and the label text.

The input reception unit 2001 may measure the length (e.g., the number of characters) of inquiry sentences upon receiving the inquiry sentence from the interface device 10 in ACT 103. The input reception unit 2001 may decide to generate the prompt based on both the inquiry sentence and the label text when the length of the inquiry sentence is less than some predetermined length, and may decide to generate the prompt based on only the inquiry sentence if the measured length of the inquiry sentence is at or above the predetermined length.

The output control unit 2006 may store and track the number of times an answer sentence regeneration is executed in the RAM 203, and may instruct the text generation unit 2003 so a prompt including the user-related information (e.g., label text) may be generated after then number of attempts is at or above some predetermined number of times. In this case, the text generation unit 2003 generates an answer sentence from a prompt including the related information after some number of regeneration attempts without the related information included.

In some examples, in ACT 102, the information transmission and reception unit 1002 may transmit an image of the user (acquired via the image-capturing unit 107) to the text generation device 20 in addition to the sensor data or instead of the sensor data. When a user image is sent, the input reception unit 2001 can extracts attribute information of the user (a user attribute) from the user image. In this context, an extracted user attribute is an example of related information. The sensor data verbalization unit 2008 provides a label text corresponding to the user attribute extracted by the input reception unit 2001.

As described above, the text generation device 20 can further include a sensor data verbalization unit 2008 that converts the sensor data acquired by the sensor data acquisition unit 1004 of the interface device 10 into label text, and a text generation unit 2003 that generates the prompt based on both the label text and the inquiry sentence.

Accordingly, since the text generation device 20 can input a prompt incorporating additional information related to the user to the text generation model 222, an answer sentence can be generated in which such additional is reflected. By including the information related to the user along with the inquiry sentence, the generation of an answer sentence more appropriate to the user can be expected. Therefore, the accuracy of answers to the user inquiry content can be improved.

### Modification 1

In an embodiment, the output unit 2007 of the text generation device 20 transmits the answer sentence to the interface device 10. However, the present disclosure is not limited thereto, and the output unit 2007 may also transmit the first classification result and the second classification result to the interface device 10 in addition to the answer sentence. Additionally, the transmission destination is not limited to the interface device 10 and may be instead, or in addition, an external server or the like.

Accordingly, the first classification result and the second classification result may be used to statistically analyze the inquiry sentences from the various users and/or the answer sentences provided by the information processing system 1 in response to inquiry sentences.

### Modification 2

In an embodiment, upon receiving the inquiry sentence or the answer sentence, the text classification model 223 outputs a classification result expressed in a vector format as calculated by a known natural language processing technique, but is not limited thereto. For example, the text classification model 223 may output the number of appearances of a specific phrase in the inquiry sentence and the answer sentence as the classification result.

In this case, the first classification result is the number of times a specific phrase (or term) appears in the inquiry sentence, and the second classification result is the number of times the specific phrase (or term) appears in the answer sentence. Therefore, the comparison unit 2005 controls the text generation unit 2003 to regenerate an answer sentence if the first classification result and the second classification result do not match with respect to the number of appearances of the specific phrase (or term). In such a case, the comparison unit 2005 causes the output unit 2007 to output the answer sentence when the number of times a specific phrase appears in the inquiry sentence corresponds to the number of times the specific phrase appears in the answer sentence or if the difference in appearances is less than some preset threshold.

### Modification 3

In an embodiment, the information input unit 1001 of the interface device 10 acquires the inquiry sentence input by a user operation from the operation unit 106, but is not limited thereto. For example, the information input unit 1001 may acquire audio data input via the microphone 109. In this case, the control unit 100 of the interface device 10 converts the audio data into text data (the inquiry sentence) and transmits this text data to the text generation device 20.

### Modification 4

In an embodiment, the display control unit 1003 of the interface device 10 displays the answer sentence on the display unit 105, but is not limited thereto. For example, the control unit 100 of the interface device 10 may convert text data (the answer sentence) into audio data and output this audio data via the speaker 108.

### Modification 5

In an embodiment, an answer sentence output by the text generation model 222 is provided to the interface device 10. However, the present disclosure is not limited thereto, and the answer sentence output by the text generation model 222 may be edited in some manner before being provided to the interface device 10. For example, if there is a need or desire to incorporate sales promotion information for a specific product or a specific manufacturer as a product proposal in the output text, the text generation unit 2003 may add promotional sentences related to a sales promotion for a product or a manufacturer to the answer sentence output from the text generation model 222 using RAG.

Programs executed by the information processing system 1 according to the various embodiments and the modifications may be stored on a computer connected to a network such as the Internet and provided by being downloaded via the network. In addition, the programs executed by the information processing system 1 according to the embodiments and the modifications may be provided, accessed, or distributed via a network such as the Internet.

The programs executed by the devices of the embodiments described above can be provided by being incorporated in a ROM, a storage unit, or the like. The programs may be provided by being recorded in a non-transitory, computer-readable recording medium such as a CD-ROM, a flexible disk (FD), a CD-R, or a digital versatile disk (DVD) as a file in an installable or executable format.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing device, comprising:
a communication interface; and
a control unit configured to:
receive an inquiry sentence from a user via the communication interface;
classify the inquiry sentence by submitting the inquiry sentence to a classification model;
generate a prompt from the inquiry sentence;
input the prompt to a generative AI to receive a response sentence from the generative AI;
classify the response sentence by submitting the response sentence to the classification model;
determine whether the classification of the inquiry sentence is similar to the classification of the response sentence;
output the response sentence to the user via the communication interface when the classification of the inquiry sentence and the response sentence are determined to be similar;
generate another prompt from the inquiry sentence and submit the other prompt to the generative AI to receive a second response sentence from the generative AI when the classification of the inquiry sentence and the response sentence are determined to be dissimilar;
classify the second response sentence by submitting the second response sentence to the classification model; and
output the second response sentence to the user via the communication interface when the classification of the inquiry sentence and the second response sentence are determined to be similar.

2. The information processing device according to claim 1, wherein
classification of the response sentence is expressed in a vector format,
classification of the inquiry sentence is expressed in a vector format, and
the determination of whether the classification of the inquiry sentence is similar to the classification of the response sentence is made based on classification results in the vector format.

3. The information processing device according to claim 1, wherein classifications of the response sentence and the inquiry sentence are performed using a bidirectional encoder representations from transformers (BERT) model.

4. The information processing device according to claim 1, wherein the generative AI is a large language model.

5. The information processing device according to claim 4, further comprising:
a storage unit, wherein
the large language model is stored in the storage unit.

6. The information processing device according to claim 1, wherein the control unit is further configured to:
acquire related information related to the user, and
include the related information with inquiry sentence to generate the prompt.

7. The information processing device according to claim 6, wherein the related information is environmental information of the user.

8. The information processing device according to claim 1, wherein the control unit is further configured to:
acquire related information related to the user, and
include the related information with inquiry sentence to generate the prompt if the inquiry sentence is shorter than a preset text limit.

9. The information processing device according to claim 1, wherein
the control unit is further configured to:
track a number of other prompts generated from the inquiry sentence without output of the second response sentence to the user,
acquire related information related to the user, and
include the related information with inquiry sentence to generate another prompt after the number of other prompts exceeds a threshold value.

10. The information processing device according to claim 9, wherein the related information is environmental sensor data.

11. An information processing system, comprising:
a user interface device; and
a text generation device communicatively connected to the user interface device, the text generation device including:
a control unit configured to:
receive an inquiry sentence from the interface device;
classify the inquiry sentence by submitting the inquiry sentence to a classification model;
generate a prompt from the inquiry sentence;
input the prompt to a generative AI to receive a response sentence from the generative AI;
classify the response sentence by submitting the response sentence to the classification model;
determine whether the classification of the inquiry sentence is similar to the classification of the response sentence;
output the response sentence to the user interface device when the classification of the inquiry sentence and the response sentence are determined to be similar;
generate another prompt from the inquiry sentence and submit the other prompt to the generative AI to receive a second response sentence from the generative AI when the classification of the inquiry sentence and the response sentence are determined to be dissimilar;
classify the second response sentence by submitting the second response sentence to the classification model; and
output the second response sentence to the user interface device when the classification of the inquiry sentence and the second response sentence are determined to be similar.

12. An information processing method, comprising:
receiving an inquiry sentence from a user via a communication interface;
classifying the inquiry sentence by submitting the inquiry sentence to a classification model;
generating a prompt from the inquiry sentence;
inputting the prompt to a generative AI to receive a response sentence from the generative AI;
classifying the response sentence by submitting the response sentence to the classification model;
determining whether the classification of the inquiry sentence is similar to the classification of the response sentence;
outputting the response sentence to the user via the communication interface when the classification of the inquiry sentence and the response sentence are determined to be similar;
generating another prompt from the inquiry sentence and submitting the other prompt to the generative AI to receive a second response sentence from the generative AI when the classification of the inquiry sentence and the response sentence are determined to be dissimilar;
classifying the second response sentence by submitting the second response sentence to the classification model; and
outputting the second response sentence to the user via the communication interface when the classification of the inquiry sentence and the second response sentence are determined to be similar.

13. The information processing method according to claim 12, wherein
classification of the response sentence is expressed in a vector format,
classification of the inquiry sentence is expressed in a vector format, and
the determination of whether the classification of the inquiry sentence is similar to the classification of the response sentence is made based on classification results in the vector format.

14. The information processing method according to claim 12, wherein classifications of the response sentence and the inquiry sentence are performed using a bidirectional encoder representations from transformers (BERT) model.

15. The information processing method according to claim 12, wherein the generative AI is a large language model.

16. The information processing method according to claim 12, further comprising:
acquiring related information related to the user; and
including the related information with inquiry sentence to generate the prompt.

17. The information processing method according to claim 16, wherein the related information is environmental information of the user.

18. The information processing method according to claim 12, further comprising:
acquiring related information related to the user; and
including the related information with inquiry sentence to generate the prompt if the inquiry sentence is shorter than a preset text limit.

19. The information processing method according to claim 12, further comprising:
tracking a number of other prompts generated from the inquiry sentence without output of the second response sentence to the user;
acquiring related information related to the user; and
including the related information with inquiry sentence to generate another prompt after the number of other prompts exceeds a threshold value.

20. The information processing method according to claim 19, wherein the related information is environmental sensor data.
